(19) United States
(12) Patent Application Publication
(10) Pub. No.: US 2007/0135491 A1
(43) Pub. Date: Jun. 14, 2007

(54) Flea control agent containing n-substitute indole derivative

(76) Inventor: Satoshi Tanabe, Kasukabe (JP)

Correspondence Address: NIELDS & LEMACK, 176 EAST MAIN STREET, SUITE 7, WESTBORO, MA, 01581, US

(21) Appl. No.: 10/593,994

(22) PCT Filed: Apr. 22, 2004
(86) PCT No.: PCT/JP04/05768

§ 371 Date: Sep. 22, 2006

(51) Int. Cl. A01N 43/40; A01N 43/38

(52) U.S. Cl. 514/337; 514/418

(57) ABSTRACT

Conventional control agents against fleas parasitic on animals do not have sufficient selective toxicity and are hence not safe for the animals to which the control agents are applied. The control agents are not always satisfactory also in control effect and quick-acting properties. Intensive studies were made on the insecticidal activity of N-substituted indole compounds against fleas and on the safety thereof for mammals including pets. As a result, it was found that an N-substituted indole derivative, e.g., 1-(3-chloro-5-trifluoromethylpyridin 2-yl)-3-(dichlorofluoromethylthio)indole, 1-(2,6-dichloro-4-trifluoromethylphenyl)-3-(dichlorofluoromethylthio)-indole, or 1-(2,6-dichloro-4-trifluoromethylphenyl)-3-(trifluoromethylthio)indole, has high insecticidal activity and quick-acting properties and is lowly toxic to mammals including pets.

### TECHNICAL FIELD

The present invention relates to a flea control agent containing an N-substituted indole derivative. This control agent is utilizable for exterminating, in particular, fleas parasitic on companion animals such as dog, cat, etc.

### BACKGROUND ART

In recent years, the appearance rate of sanitary insect pests such as fly has been greatly reduced by the marked improvement of public hygiene, but fleas parasitic on animals, in particular, human beings, companion animals (e.g. dog and cat) and the like are still in question. As chemicals for controlling the fleas, there are used, for example, organophosphorus insecticides, carbamate insecticides, pyrethroid insecticides, chemicals called IGR, chloronicotinyl insecticides such as Imidacloprid, and phenylpyrazole insecticides such as Fipronil (5-amino-1-(2,6-dichloro-4-(trifluoromethyl)phenyl)-4-((trifluoromethyl)sulfinyl)-1H-pyrazole-3-carbonitrile).

On the other hand, U.S. Pat. No. 3,290,332 and JP-A-55-151505 describe the employment of N-substituted indole derivatives as antibacterial agents.

JP-A-6-92935 describes the employment of N-substituted indole derivatives as insecticides for diamond back moth, planthoppers and the like.

In addition, JP-A-2000-26409 describes N-substituted heterocyclic substances having an aryl or heteroaryl group as the substituent, but the substituent at the 3-position of an indole ring is only a cyclic substituent in this reference.

Furthermore, U.S. Pat. No. 5,599,774 describes the employment of N-substituted indole derivatives as herbicides.

Conventional agents for controlling fleas parasitic on animals are not satisfactory in selective toxicity and are hence not safe for the animals to which the control agents are administered. The control agents are not always satisfactory also in control effect and quick-acting properties. For example, Fipronil is classified as a deleterious substance and is not sufficiently safe for the animals to which Fipronil is administered. When an N-substituted indole derivative is administered to a companion animal or the like as a flea control agent, no convenient pharmaceutical composition thereof has been known.

Under such circumstances, the present inventors earnestly investigated the insecticidal activity of N-substituted indole compounds against fleas and the safety thereof for mammals, and consequently found that a compound represented by general formula (I) has high insecticidal activity and quick-acting properties and moreover, has only low toxicity to mammals, whereby the present invention has been accomplished.

### DISCLOSURE OF THE INVENTION

That is, the present invention relates to the following.
(1) A flea control agent characterized by containing an N-substituted indole derivative represented by general formula (I): 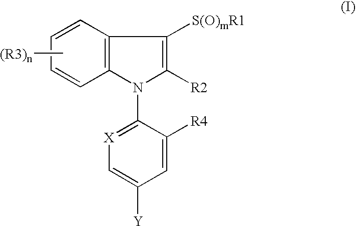
   wherein X is CH, N or C-halogen atom; Y is a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a C1-C5 alkoxyl group optionally substituted by a halogen atom(s), a halogen atom, a cyano group or a nitro group; R1 is a C1-C5 alkyl group optionally substituted by a halogen atom(s), or a C1-CS alkoxyl group optionally substituted by a halogen atom(s); R2, R3 and R4 are independently a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a halogen atom, a cyano group, a carboxyl group, a C1-C5 alkoxycarbonyl group optionally substituted by a halogen atom(s), a C1-C5 acyl group optionally substituted by a halogen atom(s), a nitro group, a cyanato group, a thiocyanato group, a C1-C5 alkoxyl group optionally substituted by a halogen atom(s), or S(O)ₖR5 wherein k is 0, 1 or 2 and R5 is a C1-C5 alkyl group optionally substituted by a halogen atom(s); m is 0, 1 or 2; and n is 1, 2, 3 or 4.
(2) A flea control agent according to the above item (1), wherein in general formula (I), X is N or C-halogen atom; Y is a hydrogen atom, a C1-C5 alkyl group optionally substituted by a halogen atom(s), a C1-C5 alkoxyl group optionally substituted by a halogen atom(s), or a halogen atom; R1 is a C1-C5 alkyl group optionally substituted by a halogen atom(s); R2, R3 and R4 are independently a hydrogen atom, a C1-C5 alkyl group optionally substituted by a halogen atom(s), a halogen atom, a carboxyl group, a C1-C5 alkoxycarbonyl group optionally substituted by a halogen atom(s), a C1-C5 acyl group optionally substituted by a halogen atom(s), or a C1-C5 alkoxyl group optionally substituted by a halogen atom(s); m is 0, 1 or 2; and n is 1 or 2.
(3) A flea control agent according to the above item (1), wherein in general formula (I), X is N or C—Cl; Y is a C1-C3 alkyl group substituted by a halogen atom(s); R1 is a C1-C3 alkyl group substituted by a halogen atom(s); R2, R3 and R4 are independently a hydrogen atom, a C1-C3 alkyl group optionally substituted by a halogen atom(s), or a halogen atom; m is 0, 1 or 2; and n is 1.
(4) A flea control agent according to the above item (1), wherein the compound of general formula (I) is 1-(3-chloro-5-trifluoromethylpyridin-2-yl)-3-(dichlorofluoromethyl-thio)indole, 1-(2,6-dichloro-4-trifluoromethylphenyl)-3-(dichlorofluoromethylthio)indole or 1-(2,6-dichloro-4-trifluoromethylphenyl)-3-(trifluoromethylthio)indole.
(5) A flea control agent according to any one of the above items (1) to (4), wherein the fleas to be controlled are fleas parasitic on companion animals.
(6) A shampoo or rinse for controlling fleas characterized by comprising a flea control agent according to any one of the above items (1) to (5).
(7) Liquid drops for controlling fleas characterized by comprising a flea control agent according to any one of the above items (1) to (5).

### BEST MODE FOR CARRYING OUT THE INVENTION

The flea control agent of the present invention is characterized by containing an N-substituted indole derivative of the above general formula (I) wherein X is CH, N or C-halogen atom; Y is a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a C1-C5 alkoxyl group optionally substituted by a halogen atom(s), a halogen atom, a cyano group or a nitro group; R1 is a C1-C5 alkyl group optionally substituted by a halogen atom(s), or a C1-C5 alkoxyl group optionally substituted by a halogen atom(s); R2, R3 and R4 are independently a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a halogen atom, a cyano group, a carboxyl group, a C1-C5 alkoxycarbonyl group optionally substituted by a halogen atom(s), a C1-C5 acyl group optionally substituted by a halogen atom(s), a nitro group, a cyanato group, a thiocyanato group, a C1-C5 alkoxyl group optionally substituted by a halogen atom(s), or S(O)ₖR5 wherein k is 0, 1 or 2 and R5 is a C1-C5 alkyl group optionally substituted by a halogen atom(s); m is 0, 1 or 2; and n is 1, 2, 3 or 4.

The term “halogen atom” used herein means a fluorine atom, a chlorine atom, a bromine atom or an iodine atom. The halogen atom is preferably a fluorine atom, a chlorine atom or a bromine atom. When any of the substituents contains a plurality of halogen atoms, these halogen atoms may be the same or different.

The substituent X in general formula (I) used in the present invention is CH, N or C-halogen atom, and is particularly preferably N or C—Cl.

The C1-C5 alkyl group for Y in general formula (I) used in the present invention includes linear or branched C1-CS alkyl groups. Specific examples thereof are methyl group, ethyl group, propyl group, isopropyl group, butyl group, tert-butyl group, pentyl group, etc. Specific examples of the C1-C5 alkyl group substituted by a halogen atom(s) are chloromethyl group, dichloromethyl group, fluoromethyl group, difluoromethyl group, trifluoromethyl group, dichlorofluoromethyl group, chlorodifluoromethyl group, trichloromethyl group, pentafluoroethyl group, etc.

The C2-C5 alkenyl group for Y in general formula (I) used in the present invention includes, for example, vinyl group, allyl group, isopropenyl group, butenyl group and pentenyl group. The C2-C5 alkenyl group substituted by a halogen atom(s) includes, for example, fluorovinyl group, chlorovinyl group, trichlorovinyl group, 3,3,3-trifluoro-propenyl group, 2-bromo-2-butenyl group and perfluoro-2-methyl-2-pentenyl group.

The C2-C5 alkynyl group for Y in general formula (I) used in the present invention includes, for example, ethynyl group and propynyl group. The C2-C5 alkynyl group substituted by a halogen atom(s) includes, for example, chloroethynyl group and chloropropynyl group.

The C1-C5 alkoxyl group for Y in general formula (I) used in the present invention includes linear or branched C1-C5 alkoxyl groups. Specific examples thereof are methoxy group, ethoxy group, propoxy group, isopropoxy group, butoxy group, tert-butoxy group, etc. Specific examples of the C1-C5 alkoxyl group substituted by a halogen atom(s) are chloro-methoxy group, bromomethoxy group, dichlorofluoromethoxy group, trifluoromethoxy group, trifluoroethoxy group, pentafluoroethoxy group, etc.

Y in general formula (I) is preferably a hydrogen atom, a C1-C5 alkyl group optionally substituted by a halogen atom(s), a C1-C5 alkoxyl group optionally substituted by a halogen atom(s), or a halogen atom, is particularly preferably a halogen atom or a C1-C3 alkyl group optionally substituted by a halogen atom(s), and is more preferably a chlorine atom, a bromine atom or a trifluoromethyl group.

The C1-C5 alkyl group optionally substituted by a halogen atom(s) for R1 in general formula (I) which is used in the present invention includes the same groups as those exemplified above as each of the C1-C5 alkyl group for Y and the C1-C5 alkyl group substituted by a halogen atom(s) for Y. Specific examples thereof are also the same as those given above in the case of Y.

The C1-C5 alkoxyl group optionally substituted by a halogen atom(s) for R1 in general formula (I) which is used in the present invention includes the same groups as those exemplified above as each of the C1-C5 alkoxyl group for Y and the C1-C5 alkoxyl group substituted by a halogen atom(s) for Y. Specific examples thereof are also the same as those given above in the case of Y.

R1 in general formula (I) is preferably a C1-C5 alkyl group optionally substituted by a halogen atom(s), in particular, a C1-C3 alkyl group substituted by a halogen atom(s). Specific examples thereof are trifluoromethyl group, dichlorofluoromethyl group, chlorodifluoromethyl group and trichloromethyl group.

The C1-C5 alkyl group optionally substituted by a halogen atom(s) for each of R2, R3 and R4 in general formula (I) which is used in the present invention includes the same groups as those exemplified above as each of the C1-C5 alkyl group for Y and the C1-C5 alkyl group substituted by a halogen atom(s) for Y. Specific examples thereof are also the same as those given above in the case of Y.

The C2-C5 alkenyl group optionally substituted by a halogen atom(s) for each of R2, R3 and R4 in general formula (I) which is used in the present invention includes the same groups as those exemplified above as each of the C2-C5 alkenyl group for Y and the C2-C5 alkenyl group substituted by a halogen atom(s) for Y. Specific examples thereof are also the same as those given above in the case of Y.

The C2-C5 alkynyl group optionally substituted by a halogen atom(s) for each of R2, R3 and R4 in general formula (I) which is used in the present invention includes the same groups as those exemplified above as each of the C2-C5 alkynyl group for Y and the C2-C5 alkynyl group substituted by a halogen atom(s) for Y. Specific examples thereof are also the same as those given above in the case of Y.

The C1-C5 alkoxycarbonyl group optionally substituted by a halogen atom(s) for each of R2, R3 and R4 in general formula (I) which is used in the present invention includes, for example, methoxycarbonyl group, ethoxycarbonyl group, propoxycarbonyl group, butoxycarbonyl group, tert-butoxycarbonyl group and 2,2,2-trifluoroethoxycarbonyl group.

The C1-C5 acyl group optionally substituted by a halogen atom(s) for each of R2, R3 and R4 in general formula (I) which is used in the present invention includes, for example, formyl group, acetyl group, propionyl group, butyryl group, isobutyryl group, valeryl group, pivaloyl group, trifluoroacetyl group, trichloroacetyl group and 3,3,3-trifluoropropionyl group.

The C1-C5 alkoxyl group optionally substituted by a halogen atom(s) for each of R2, R3 and R4 in general formula (I) which is used in the present invention includes the same groups as those exemplified above as each of the C1-C5 alkoxyl group for Y and the C1-C5 alkoxyl group substituted by a halogen atom(s) for Y. Specific examples thereof are also the same as those given above in the case of Y.

The C1-C5 alkyl group optionally substituted by a halogen atom(s) for R5 in S(O)ₖR5 for each of R2, R3 and R4 in general formula (I) which is used in the present invention includes the same groups as those exemplified above as each of the C1-C5 alkyl group for Y and the C1-C5 alkyl group substituted by a halogen atom(s) for Y. Specific examples thereof are also the same as those given above in the case of Y. In addition, k may be 0, 1 or 2.

R2 in general formula (I) is preferably a hydrogen atom, an unsubstituted C1-C5 alkyl group or a halogen atom, and is particularly preferably a hydrogen atom or a methyl group.

R3 in general formula (I) is preferably a hydrogen atom, a C1-C5 alkoxyl group optionally substituted by a halogen atom(s), a halogen atom or a cyano group, and is particularly preferably a hydrogen atom, a fluorine atom, a chlorine atom, a bromine atom, a methoxy group or a cyano group. The substitution position of R3 is preferably the 4-, 5-or 6-position of the indole ring, in particular, the 5-position.

R4 in general formula (I) is preferably a halogen atom, a C1-C5 alkyl group optionally substituted by a halogen atom(s), or a C1-C5 alkoxyl group optionally substituted by a halogen atom(s), and is particularly preferably a chlorine atom, a fluorine atom, a trifluoromethyl group or a trifluoromethoxy group.

Although the integer m in general formula (I) used in the present invention may be 0, 1 or 2, it is preferably 0 or 2.

Although the integer n in general formula (I) used in the present invention may be 1, 2, 3 or 4, it is preferably 1 or 2, in particular, 1.

The compound of general formula (I) used in the flea control agent of the present invention includes 1-(3-chloro-5-trifluoromethylpyridin-2-yl)-3-(dichlorofluoromethyl-thio)indole, 1-(3-chloro-5-trifluoromethylpyridin-2-yl)-3-(dichlorofluoromethylthio)-5-fluoroindole, 1-(3-chloro-5-trifluoromethylpyridin-2-yl)-3-(dichlorofluoromethylthio)-2-methylindole, 1-(2,6-dichloro-4-trifluoromethylphenyl)-3-(dichlorofluoromethylthio)indole, 1-(2,6-dichloro-4-trifluoromethylphenyl)-3-(trifluoromethylthio)indole and the like. Especially preferable examples thereof are 1-(3-chloro-5-trifluoromethylpyridin-2-yl)-3-(dichlorofluoromethyl-thio)indole, 1-(2,6-dichloro-4-trifluoromethylphenyl)-3-(dichlorofluoromethylthio)indole and 1-(2,6-dichloro-4-trifluoromethylphenyl)-3-(trifluoromethylthio)indole.

When the compound of the above general formula (I) is used as a flea control agent, the N-substituted indole derivative may be used alone as it is, though it is preferably administered to the whole or a part of a living body to be treated, by any of, for example, the following various methods acceptable to parasiticides in order to control parasites more easily and effectively: a method of using the derivative in the form of liquid drops, a solution, a spray, a foamy preparation, tablets, granules, fine granules, a powder, capsules, an injection, a suppository, a chewable preparation or the like; a method of using the derivative in admixture with a shampoo or a rinse; a method of using the derivative by its incorporation into a collar; and a method of using the derivative in admixture with feed. Of such preparation forms, the liquid drops and the shampoo or rinse are especially preferable.

For example, the liquid drops are a liquid percutaneous preparation containing 0.1 to 20 parts by weight of the N-substituted indole derivative and 10 to 95 parts by weight of a glycol or a glycol monoalkyl ether. If necessary, other components may be properly incorporated into the liquid drops. As the other components, there are exemplified liquid carriers easily miscible with the glycol or glycol monoalkyl ether, such as alcohols (e.g. methanol, ethanol, isopropanol, tert-butanol and benzyl alcohol), propylene carbonate, N-methyl-2-pyrrolidone, water, etc.

The liquid drops are usually administered to an animal by a topical treatment method such as spot-on treatment or pour-on treatment. The administration permits efficient control of external parasites of the animal.

The spot-on treatment method is a method in which the external parasites are controlled by dropping a liquid agent for controlling the external parasites, for example, onto the skin at the back of the shoulder blade of the animal.

The pour-on treatment method is a method in which a liquid agent for controlling the external parasites is poured along the dorsal midline of the animal and then this control agent spreads over the surface of the body, whereby the external parasites are controlled.

The amount of the control agent administered to the animal is usually, for example, 0.001 ml/kg to 10 ml/kg in terms of a composition and is, for example, 0.1 mg/kg to 3000 mg/kg in terms of the N-substituted indole derivative.

For example, the spray is a liquid agent for controlling external parasites which contains 0.1 to 20 parts by weight of the N-substituted indole derivative and 10 to 95 parts by weight of a glycol or a glycol monoalkyl ether, an alcohol and a surfactant. If necessary, the spray may properly contain other components. The glycol or glycol monoalkyl ether includes, for example, diethylene glycol monoethyl ether and propylene glycol. The alcohol includes, for example, methanol, ethanol, isopropanol, tert-butanol and benzyl alcohol. The surfactant includes, for example, anionic surfactants, cationic surfactants and amphoteric surfactants, such as sodium higher alcohol sulfate, stearylmethyl-ammonium chloride, polyoxyethylene alkylphenyl ether, laurylbetaine, etc. The amount of this control agent administered to an animal per kg of the animal is usually about 0.01 ml/kg to about 10 ml/kg in terms of a composition and about 0.1 mg/kg to about 3000 mg/kg in terms of the N-substituted indole derivative.

The capsules, pills or tablets may be prepared by properly dividing the N-substituted indole derivative, mixing the derivative with a diluent or a carrier, adding thereto a disintegrating agent and/or a binder, such as starch, lactose, talc, magnesium stearate or the like, and if necessary, compressing the resulting mixture into tablets.

The injection should be prepared as a sterile solution. The sterile solution may contain other substances such as a salt or glucose in an amount sufficient to make the solution isotonic with regard to blood. A liquid carrier usable in the injection includes vegetable oils such as sesame oil, etc.; glycerides such as triacetin, etc.; and esters such as benzyl benzoate, isopropyl myristate, fatty acid derivatives of propylene glycol, etc., as well as organic solvents such as pyrrolidone, glycerol formal, etc. This pharmaceutical composition is prepared by dissolving or suspending the active ingredient in the above-exemplified liquid carrier so that the composition may contain the active ingredient in an amount of, for example, 0.01 to 10% by weight.

As to the method of using the N-substituted indole derivative in admixture with a shampoo or a rinse, such a composition may be prepared by incorporating the N-substituted indole derivative into a commercial shampoo or rinse in an amount of 0.01 to 10%, preferably 0.1 to 2%. In addition, it is also possible to prepare a shampoo or rinse for exclusive use comprising the components of a conventional shampoo or rinse for animals and the N-substituted indole derivative. The concentration of the N-substituted indole derivative in the shampoo or rinse for exclusive use is about 0.01 to about 10%, preferably about 0.1 to about 2%. Specifically, the shampoo or rinse for exclusive use is prepared, for example, from the N-substituted indole derivative, an acceptable solvent, a solubilizer or an emulsifier, a wash or a treatment, water and the like. The shampoo or rinse for exclusive use may further contain an aromatic, a thickening agent or a viscosity modifier, a pH adjuster and the like. The acceptable solvent includes, for example, glycols or glycol monoalkyl ethers, and alcohols such as methanol, ethanol, isopropanol, tert-butanol, benzyl alcohol, etc.

The other pharmaceutical compositions may also be prepared by adding components which are considered necessary for preparing the compositions, such as generally known surfactants, diluents, additives, stabilizers, etc.

In addition, the flea control agent of the present invention may be administered together with animal feed. For the administration, concentrated feed containing the control agent or a premix may be prepared.

The flea control agent of the present invention may be mixed and used together with not only other insecticides, nematicides and other pulicides but also synergists and the like. As these chemicals, there are used, for example, organophosphorus compounds such as Diazinon, DDVP (2,2-dichlorovinyl-O,O-dimethyl phosphate), etc.; carbamate compounds such as Carbosulfan, etc.; pyrethroid compounds such as Cycloprothrin, Ethofenprox, Allethrin, Permethrin, etc.; chloronicotinyl compounds such as Imidacloprid, etc.; phenylpyrazole compounds such as Fipronil, etc.; benzoylurea compounds such as Lufenuron, etc.; juvenile-hormone-like compounds such as Methoprene, Pyriproxyfen, etc.; hydrazine compounds such as Chromafenozide, Tebufenozide, etc.; macrolide compounds such as Milbemectin, Ivermectin, Moxydectin, Seramectin, etc.; Buprofezin; and Azadirachtin.

As to the administration methods of the above-mentioned pharmaceutical compositions, the compositions may be administered by conventional methods, respectively. The dose of the composition is not particularly limited so long as it is effective in controlling fleas without side effects. It is usually about 0.01 mg/kg to about 3000 mg/kg, preferably about 0.1 mg/kg to about 1500 mg/kg, particularly preferably about 1 mg/kg to about 500 mg/kg.

The interval between administrations of the flea control agent of the present invention may be set on the basis of a period during which the active ingredient of the control agent remains in an effective amount on or in a living thing to which the control agent is administered, and it can exhibit the desired effect sufficiently. The interval is varied depending on the kind of the living thing, the compound used and the pharmaceutical form. For example, in the case of the liquid drops, the interval between administrations is about 1 month to about 1 year, preferably about 1 month to about 6 months, particularly preferably about 1 month to about 3 months.

Fleas controllable by the flea control agent of the present invention are not particularly limited so long as they are parasitic on mammals. Examples thereof are, in particular, fleas parasitic on companion animals. Specific examples thereof are human flea (Pulex irritans), dog flea (Ctenocephalides canis), cat flea (Ctenocephalides felis), rat flea, etc.

The companion animals refer to dogs, cats, hamsters, rabbits and the like, which are commonly kept by the households.

Next, typical examples of the compound of the above general formula (I) used in the present invention are listed in Table 1.

TABLE 1

| NO. | X | Y | m | R1 | R2 | R3 | R4 | n |
|---|---|---|---|---|---|---|---|---|
| 1 | N | CF3 | 0 | CCl2F | H | H | Cl | 1 |
| 2 | N | CF3 | 0 | CCl2F | H | 5-F | Cl | 1 |
| 3 | N | CF3 | 0 | CCl2F | H | 5-Cl | Cl | 1 |
| 4 | N | CF3 | 0 | CCl2F | H | 5-Br | Cl | 1 |
| 5 | N | CF3 | 0 | CCl2F | H | 5-OCH3 | Cl | 1 |
| 6 | N | CF3 | 0 | CCl2F | H | 5-CN | Cl | 1 |
| 7 | N | CF3 | 0 | CCl2F | H | 4-Cl | Cl | 1 |
| 8 | N | CF3 | 0 | CCl2F | H | 6-Cl | Cl | 1 |
| 9 | N | CF3 | 0 | CF3 | H | H | Cl | 1 |
| 10 | N | CF3 | 0 | CF3 | H | 5-Cl | Cl | 1 |
| 11 | N | CF3 | 0 | CCl3 | H | H | Cl | 1 |
| 12 | N | CF3 | 0 | CCl3 | H | 5-Cl | Cl | 1 |
| 13 | N | Cl | 0 | CCl2F | H | H | Cl | 1 |
| 14 | N | CF3 | 0 | CCl2F | CH3 | H | Cl | 1 |
| 15 | N | CF3 | 1 | CCl2F | H | H | Cl | 1 |
| 16 | N | CF3 | 2 | CCl2F | H | H | Cl | 1 |
| 17 | CCl | CF3 | 0 | CCl2F | H | H | Cl | 1 |
| 18 | CCl | CF3 | 0 | CCl2F | H | 5-F | Cl | 1 |
| 19 | CCl | CF3 | 0 | CCl2F | H | 5-Cl | Cl | 1 |
| 20 | CCl | CF3 | 0 | CCl2F | H | 5-Br | Cl | 1 |
| 21 | CCl | CF3 | 0 | CCl2F | H | 5-OCH3 | Cl | 1 |
| 22 | CCl | CF3 | 0 | CCl2F | H | 5-CN | Cl | 1 |
| 23 | CCl | CF3 | 0 | CCl2F | H | 4-Cl | Cl | 1 |
| 24 | CCl | CF3 | 0 | CCl2F | H | 6-Cl | Cl | 1 |
| 25 | CCl | CF3 | 0 | CF3 | H | H | Cl | 1 |
| 26 | CCl | CF3 | 0 | CF3 | H | 5-Cl | Cl | 1 |
| 27 | CCl | CF3 | 0 | CCl3 | H | H | Cl | 1 |
| 28 | CCl | CF3 | 0 | CCl3 | H | 5-Cl | Cl | 1 |
| 29 | CCl | Cl | 0 | CCl2F | H | H | Cl | 1 |
| 30 | CCl | CF3 | 0 | CCl2F | CH3 | H | Cl | 1 |
| 31 | CCl | CF3 | 1 | CCl2F | H | H | Cl | 1 |
| 32 | CCl | CF3 | 2 | CCl2F | H | H | Cl | 1 |

### EXAMPLES

Flea control effect, an emulsion, liquid drops and a shampoo•rinse obtained by the use of an N-substituted indole derivative are described below as working examples, but these working examples are not intended in any way to limit the scope of the present invention.

### Example 1

### Emulsion

Eighty-five parts by weight of dimethyl sulfoxide, 85 parts by weight of xylene and 20 parts by weight of Newcalgen 900 (mfd. by Takemoto Oil Fat Co., Ltd.) were mixed to effect dissolution. Ninety parts by weight of the resulting mixed solution was mixed with 10 parts by weight of compound No. 17 or No. 25 listed in Table 1, to obtain an emulsion.

### Example 2

### Liquid Drops

Seventy-five parts by weight of diethylene glycol monoethyl ether and 15 parts by weight of ethanol were mixed to effect dissolution. Eighty parts by weight of the resulting mixed solution was mixed with 20 parts by weight of compound No. 17 or No. 25 to obtain 20% liquid drops. In the same manner as above, 10% and 30% liquid drops were also prepared.

### Example 3

### Shampoo•Rinse

Compound No. 25 listed in Table 1 was added to a commercial shampoo or rinse for dog or cat in an amount of 1% and sufficiently stirred to obtain a homogeneous mixture. Thus, a shampoo for controlling fleas or a rinse for controlling fleas was obtained.

### Example 4

### Effect of N-Substituted Indole Derivatives on Cat Flea (1)

Each compound was dissolved in acetone to a predetermined concentration and 0.1 ml of the resulting solution was dropped into the bottom of a glass tube with a diameter of 2.8 cm and a height of 12 cm and air-dried. After the air-drying, 10 adult cat fleas were placed in the glass tube and the glass tube was closed with nylon mesh and allowed to stand under conditions of a room temperature of 26° C. and a humidity of 80%. The knocked-down (KD) fleas after 3 hours and the dead and alive after 24 hours and 48 hours were counted, and the knocking-down rate and the mortality were calculated. Table 2 shows the test results obtained for compounds Nos. 1, 2, 3, 14, 17, 19, 25 and 32 listed in Table 1. Fipronil was used as a positive control. In a control experiment, no treatment with an agent was carried out.

TABLE 2

| | | After 3 | After 1 day | After 2 days |
|---|---|---|---|---|
| Compound | (mg/tube) | hours (KD) | (mortality) | (mortality) |
| 1 | 1 | 80 | 100 | 100 |
| | 0.1 | 0 | 100 | 100 |
| | 0.01 | 0 | 70 | 100 |
| | 0.001 | 0 | 10 | 40 |
| 2 | 1 | 0 | 100 | 100 |
| | 0.1 | 0 | 100 | 100 |
| | 0.01 | 0 | 10 | 50 |
| | 0.001 | 0 | 0 | 0 |
| 3 | 1 | 0 | 50 | 90 |
| | 0.1 | 0 | 40 | 70 |
| | 0.01 | 0 | 10 | 20 |
| | 0.001 | 0 | 20 | 20 |
| 14 | 1 | 0 | 100 | 100 |
| | 0.1 | 0 | 100 | 100 |
| | 0.01 | 0 | 50 | 100 |
| | 0.001 | 0 | 20 | 30 |
| 17 | 1 | 50 | 100 | 100 |
| | 0.1 | 0 | 100 | 100 |
| | 0.01 | 0 | 70 | 100 |
| | 0.001 | 0 | 10 | 40 |
| 19 | 1 | 0 | 100 | 100 |
| | 0.1 | 0 | 60 | 100 |
| | 0.01 | 0 | 30 | 90 |
| 25 | 1 | 100 | 90 | 100 |
| | 0.1 | 10 | 100 | 100 |
| | 0.01 | 0 | 70 | 100 |
| | 0.001 | 0 | 0 | 30 |
| 32 | 1 | 0 | 100 | 100 |
| | 0.1 | 0 | 30 | 100 |
| | 0.01 | 0 | 0 | 20 |
| | 0.001 | 0 | 0 | 0 |
| Fipronil | 1 | 0 | 100 | 100 |
| | 0.1 | 0 | 100 | 100 |
| | 0.01 | 0 | 20 | 90 |
| | 0.001 | 0 | 20 | 20 |
| Control | | 0 | 0 | 0 |

As can be seen from the results shown in Table 2, the N-substituted indole derivatives as compounds No. 17 and No. 25 showed a cat flea mortality of 70% after 1 day at a concentration of as low as 0.01 mg. This fact indicates the high insecticidal activity and quick-acting properties of the N-substituted indole derivatives.

### Example 5

### Effect of an N-Substituted Indole Derivative on Cat Flea (2)

Each of compound No. 17 and Fipronil was dissolved in a base ingredient for preparing liquid drops (a mixed solution consisting of 75 parts by weight of diethylene glycol monoethyl ether and 15 parts by weight of ethanol) to a concentration of 10%, and 0.5 ml of the resulting solution was dropped on the back of the shoulder blade of a cat having 30 cat fleas made parasitic thereon before 1 day. Fleas that had fallen from the cat body were counted at intervals of 2 hours until 8 hours after the dropping of the solution, and the cumulative fall rate was calculated. In addition, fleas that had fallen in 24 hours were counted and the cumulative fall rate after 1 day was calculated. Two days after the dropping, the living fleas on the cat body were counted by the use of a flea-removing comb. Table 3 shows the test results.

TABLE 3

| | Cumulative fall rate (%) | | | | |
|---|---|---|---|---|---|
| | After 2 | After 4 | After 6 | After 8 | After 24 |
| Compound | hours | hours | hours | hours | hours |
| 17 | 0 | 15 | 37 | 47 | 100 |
| Fipronil | 0 | 3 | 20 | 27 | 90 |

As can be seen from the results shown in Table 3, compound No. 17 was effective in allowing the fleas to fall from the cat body quickly. The fleas that had fallen died within several hours. On the other hand, on the body of the cat on which Fipronil had been dropped as a control, three dead fleas were found 24 hours after the dropping.

### Example 6

### Effect of an N-Substituted Indole Derivative on Cat Flea (3)

Compound No. 17 was dissolved in a base ingredient for preparing liquid drops (a mixed solution consisting of 75 parts by weight of diethylene glycol monoethyl ether and 15 parts by weight of ethanol) to a concentration of 10%, and 0.5 ml of the resulting solution was dropped on the back of the shoulder blade of a cat. After the dropping, 30 adult cat fleas were made parasitic on the cat body after a predetermined number of weeks. On the second day after this inoculation with the parasites, the living fleas on the cat body were counted by the use of a flea-removing comb. Table 4 shows the test results.

TABLE 4

| | Number of weeks after administration | | | | |
|---|---|---|---|---|---|
| | 1 | 2 | 4 | 6 | 8 |
| Number of living fleas on the | 0 | 0 | 0 | 6 | 13 |
| second day after inoculation | | | | | |

As can be seen from the results shown in Table 4, compound No. 17 completely killed the fleas until 4 weeks after the dropping. At a number of weeks after administration of 6 weeks, six of the 30 fleas were not killed. At a number of weeks after administration of 8 weeks, thirteen of the 30 fleas were not killed. That is, the aftereffect of compound No. 17 lasted for a long period of about 6 weeks.

### Test Example 1

### Toxicity of N-Substituted Indole Derivatives to Mouse

The compound listed in Table 1 or Fipronil was dissolved in olive oil to a predetermined concentration, and the resulting solution was directly administered into the stomachs of std:ddy strain male mice by the use of a probe. The dose was 30 mg/kg or 100 mg/kg. Whether the mice were alive or dead was observed 3 hours, 1 day, 7 days and 14 days after the administration. Table 5 shows the test results obtained for compounds Nos. 14, 17 and 25 listed in Table 1.

TABLE 5

| | Cumulative mortality (number of deaths/number | | | | |
|---|---|---|---|---|---|
| | of test animals) | | | | |
| | Dose | After 3 | After 1 | After 7 | After 14 |
| Compound | (mg/kg) | hours | day | days | days |
| 14 | 30 | 0/5 | 0/5 | 0/5 | 0/5 |
| | 100 | 0/5 | 0/5 | 0/5 | 0/5 |
| 17 | 30 | 0/5 | 0/5 | 0/5 | 0/5 |
| | 100 | 0/5 | 0/5 | 0/5 | 0/5 |
| 25 | 30 | 0/5 | 0/5 | 0/5 | 0/5 |
| | 100 | 0/5 | 0/5 | 0/5 | 0/5 |
| Fipronil | 30 | 0/5 | 1/5 | 1/5 | 1/5 |
| | 100 | 1/5 | 5/5 | 5/5 | 5/5 |

As can be seen from the results shown in Table 5, this test indicates that the N-substituted indole derivatives have only low toxicity to mouse.

### Test Example 2

### Toxicity of an N-Substituted Indole Derivative of Cat

Compound No. 17 was dissolved in a base ingredient for preparing liquid drops (a mixed solution consisting of 75 parts by weight of diethylene glycol monoethyl ether and 15 parts by weight of ethanol) to a concentration of 10%, 20% or 30%, and 0.5 ml of the resulting solution was dropped on the back of the shoulder blade of a cat in a spot-on manner. After the dropping, the clinical symptom of the cat was observed. Table 6 shows the test results.

TABLE 6

| Compound | Dropping concentration (%) | Clinical symptom |
|---|---|---|
| 17 | 10 | No sign was |
| | 20 | recognized |
| | 30 | |

As can be seen from the results shown in Table 6, no abnormal sign due to the spot-on dropping of the solution for 10, 20 or 30% liquid drops of compound No. 17 was recognized, namely, no influence of the agent was recognized. This fact indicates that compound No. 17 has only low toxicity also to a cat.

### INDUSTRIAL APPLICABILITY

The flea control agent containing an N-substituted indole derivative of the present invention has control effect on fleas parasitic on animals and exhibits a marked control effect on, in particular, cat flea which has recently become parasitic on hosts other than cat. This fact suggests that the control agent has excellent control effect and quick-acting properties when used for controlling fleas parasitic on companion animals and the like. The quick-acting properties of the control agent mean that animals treated with the control agent are hardly infected with diseases carried by fleas, and the like. In addition, the flea control agent of the present invention is very useful because it has only low toxicity to mammals including pets. Furthermore, a more convenient pharmaceutical composition for controlling fleas is provided by making the control agent into an emulsion, liquid drops or a shampoo•rinse.

1. A flea control agent characterized by containing an N-substituted indole derivative represented by general formula (I): 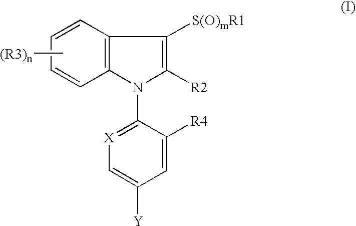
wherein X is CH, N or C-halogen atom; Y is a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a C1-C5 alkoxyl group optionally substituted by a halogen atom(s), a halogen atom, a cyano group or a nitro group; R1 is a C1-C5 alkyl group optionally substituted by a halogen atom(s), or a C1-C5 alkoxyl group optionally substituted by a halogen atom(s); R2, R3 and R4 are independently a hydrogen atom, a C1-C5 alkyl group optionally substituted by a halogen atom(s), a C2-C5 alkenyl group optionally substituted by a halogen atom(s), a C2-C5 alkynyl group optionally substituted by a halogen atom(s), a halogen atom, a cyano group, a carboxyl group, a C1-C5 alkoxycarbonyl group optionally substituted by a halogen atom(s), a C1-C5 acyl group optionally substituted by a halogen atom(s), a nitro group, a cyanato group, a thiocyanato group, a C1-C5 alkoxyl group optionally substituted by a halogen atom(s), or S(O)ₖR5 wherein k is 0, 1 or 2 and R5 is a C1-C5 alkyl group optionally substituted by a halogen atom(s); m is 0, 1 or 2; and n is 1, 2, 3 or 4.

2. A flea control agent according to claim 1, wherein in general formula (I), X is N or C-halogen atom; Y is a hydrogen atom, a C1-C5 alkyl group optionally substituted by a halogen atom(s), a C1-C5 alkoxyl group optionally substituted by a halogen atom(s), or a halogen atom; R1 is a C1-C5 alkyl group optionally substituted by a halogen atom(s); R2, R3 and R4 are independently a hydrogen atom, a C1-C5 alkyl group optionally substituted by a halogen atom(s), a halogen atom, a carboxyl group, a C1-C5 alkoxycarbonyl group optionally substituted by a halogen atom(s), a C1-C5 acyl group optionally substituted by a halogen atom(s), or a C1-C5 alkoxyl group optionally substituted by a halogen atom(s); m is 0, 1 or 2; and n is 1 or 2.

3. A flea control agent according to claim 1, wherein in general formula (I), X is N or C—Cl; Y is a C1-C3 alkyl group substituted by a halogen atom(s); R1 is a C1-C3 alkyl group substituted by a halogen atom(s); R2, R3 and R4 are independently a hydrogen atom, a C1-C3 alkyl group optionally substituted by a halogen atom(s), or a halogen atom; m is 0, 1 or 2; and n is 1.

4. A flea control agent according to claim 1, wherein the compound of general formula (I) is 1-(3-chloro-5-trifluoromethylpyridin-2-yl)-3-(dichlorofluoromethyl-thio)indole, 1-(2,6-dichloro-4-trifluoromethylphenyl)-3-(dichlorofluoromethylthio)indole or 1-(2,6-dichloro-4-trifluoromethylphenyl)-3-(trifluoromethylthio)indole.

5. A flea control agent according to any one of claims 1 to 4, wherein the fleas to be controlled are fleas parasitic on companion animals.

6. A shampoo or rinse for controlling fleas characterized by comprising a flea control agent according to any one of claims 1 to 5.

7. Liquid drops for controlling fleas characterized by comprising a flea control agent according to any one of claims 1 to 5.
